(19) United States
(12) Patent Application Publication
(10) Pub. No.: US 2022/0197100 A1
(43) Pub. Date: Jun. 23, 2022

(54) SUPPORT SYSTEM FOR ELECTROCHROMIC DEVICES

(71) Applicant: SAGE ELECTROCHROMICS, INC., Faribault, MN (US)

(72) Inventors: Robert J. ANGLEMIER, Waterville, MN (US); Cody VANDERVEEN, Faribault, MN (US); Jean-Christophe GIRON, Edina, MN (US); Rino MESSERE, Modave (BE)

(21) Appl. No.: 17/645,091

(22) Filed: Dec. 20, 2021

Related U.S. Application Data
(60) Provisional application No. 63/128,486, filed on Dec. 21, 2020.

(51) Int. Cl. G02F 1/153

(52) U.S. Cl. CPC G02F 1/1533; G02F 1/161

(57) ABSTRACT

A frameless support system for electroactive devices is disclosed. The frameless system can include a non-penetrating mount, a first electroactive device, and a second electroactive device adjacent the first electroactive device where the non-penetrating mount connects the first electroactive device to the second electroactive device, and where the non-penetrating mount is on only a single surface of the first and second electroactive devices. In a further embodiment, and least one of the first and second electroactive devices can further include: a substrate; a first transparent conductive layer; a second transparent conductive layer between the substrate and the first transparent conductive layer; an electrochromic layer between the first transparent conductive layer and the second transparent conductive layer; and an anodic electrochemical layer between the first transparent conductive layer and the second transparent conductive layer.

### CROSS-REFERENCE TO RELATED APPLICATION(S)

This application claims priority under 35 U.S.C. § 119(e) to U.S. Provisional Application No. 63/128,486, entitled “SUPPORT SYSTEM FOR ELECTROCHROMIC DEVICES,” by Robert J. ANGLEMIER et al., filed Dec. 21, 2021, which is assigned to the current assignee hereof and incorporated herein by reference in its entirety.

### FIELD OF THE DISCLOSURE

The present disclosure is related to electrochemical devices and systems of supporting the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. Electrochromic devices alter the color, transmittance, absorbance, and reflectance of energy by inducing a change the electrochemical material. Specifically, the optical modulation is the result of the simultaneous insertion and extraction of electrons and charge compensating ions in the electrochemical material lattice.

Such devices can be within an insulated glazing unit that includes airspace around the electrochromic device. The surrounding space can both protect and insulate the EC. Support systems for such devices need to maintain the integrity of not only the electrochromic device itself but also of the surrounding insulating space.

As such, further improvements are sought in supporting electrochromic devices.

### BRIEF DESCRIPTION OF THE DRAWINGS

FIG. 1A illustrates a planar view of a system that can include more than one electrochromic device and frameless support system, according to one embodiment.

FIG. 1B illustrates a planar view of a system that can include more than one electrochromic device and frameless support system, according to one embodiment.

FIG. 2A is a schematic representation of the mount used in the system 100 of FIG. 1, according to one embodiment.

FIG. 2B is a schematic representation of the mount used in the system 100 of FIG. 1.

FIG. 2C is a schematic representation of the mount used in the system 100 of FIG. 1.

FIG. 3 is a schematic representation of the mount used in the system 100 of FIG. 1.

FIG. 4 is a schematic cross-section of an electrochromic device, according to one embodiment.

FIG. 5 is a schematic illustration of an insulated glazing unit, according the embodiment of the current disclosure.

FIG. 6A is a schematic representation of the wiring of the support system, according to one embodiment.

FIG. 6B is a schematic representation of the wiring of the support system, according to one embodiment.

FIG. 6C is a schematic representation of the wiring of the support system, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated.

Patterned features, which include bus bars, holes, etc., can have a width, a depth or a thickness, and a length, wherein the length is greater than the width and the depth or thickness. As used in this specification, a diameter is a width for a circle, and a minor axis is a width for an ellipse.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

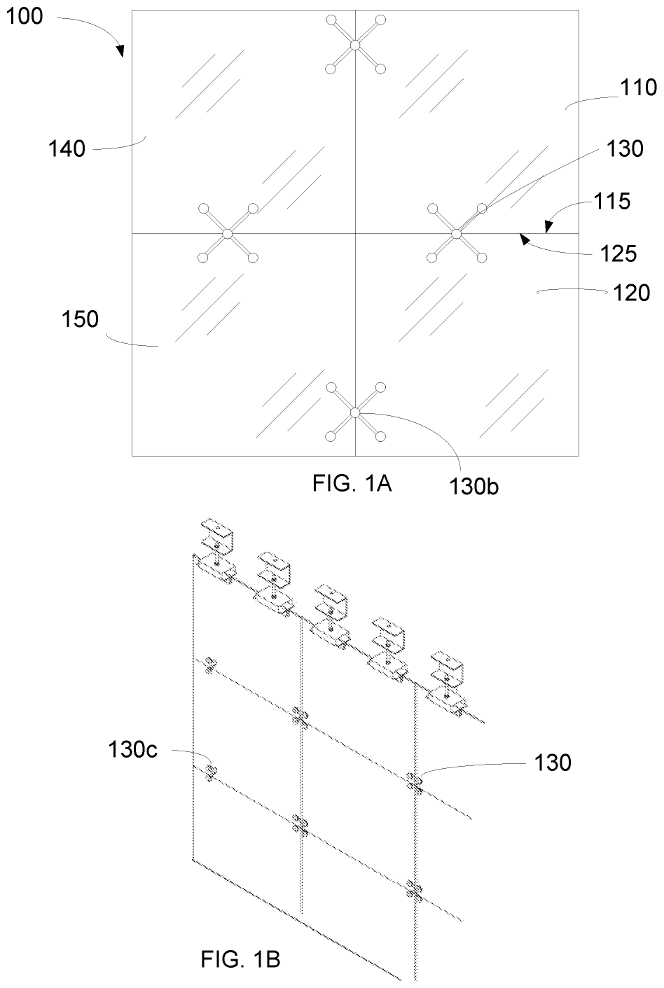

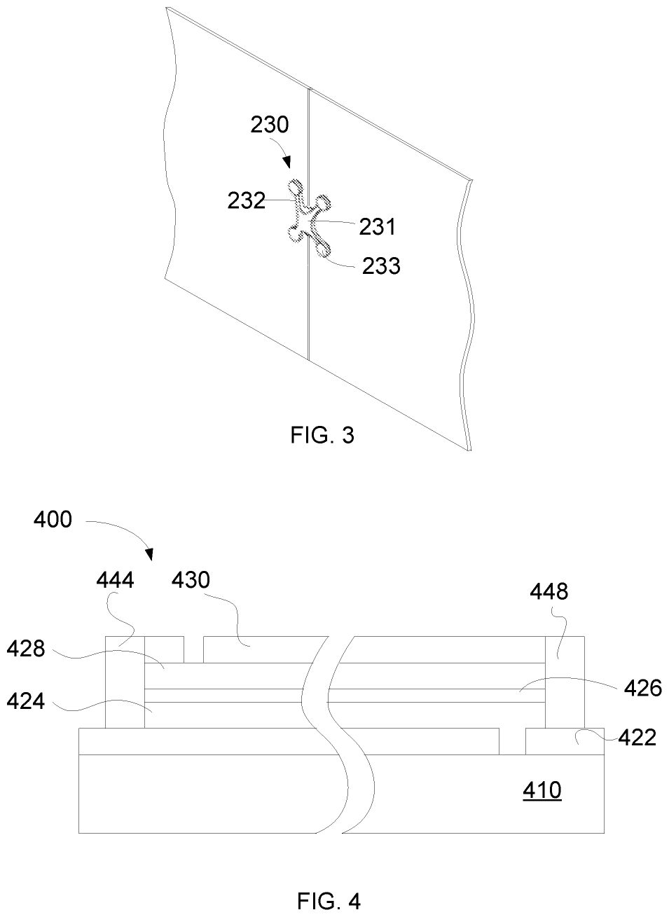

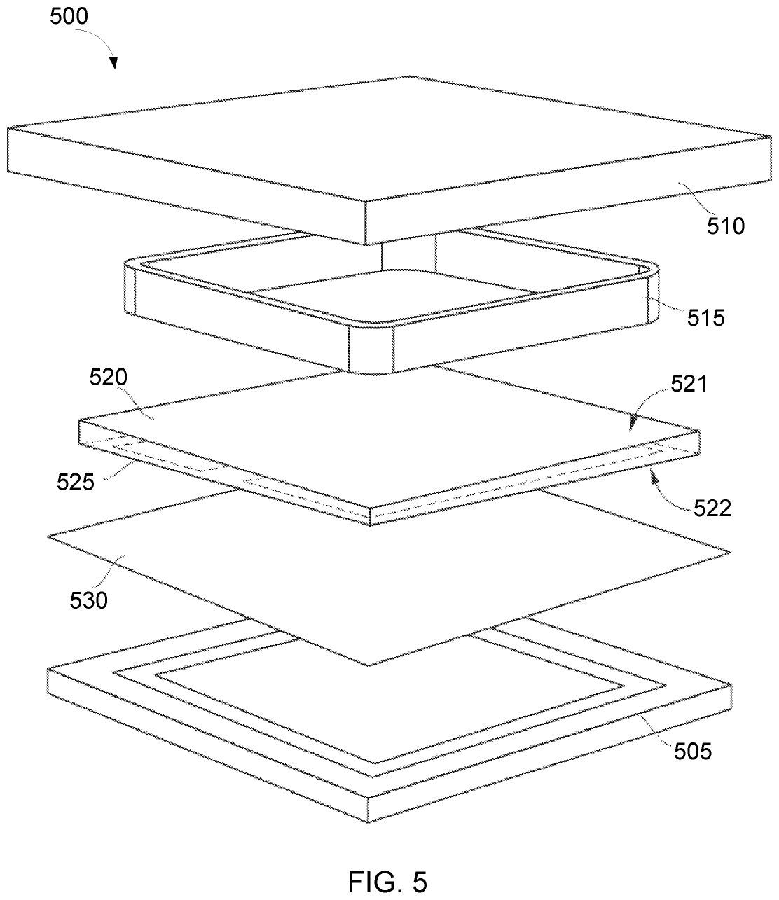

FIG. 1A illustrates a planar view of a system 100 that can include more than one electrochromic devices, and support system. Each electrochromic device can be on a substrate and subsequently processed. In one embodiment, each of the electrochromic devices can be processed as a laminate such that the system 100 can include more than one laminate. In another embodiment, each of the electrochromic devices can be processed as an insulated glazing unit (IGU) such that the system 100 can include more than one insulated glazing unit (IGU), as described in more detail below with respect to FIG. 3 and FIG. 5.

One embodiment of the system 100 can include a first electrochromic device 110 connected to a second electrochromic device 120 using a mount 130, as seen in FIG. 1. In one embodiment, the mount 130 is a spider mount. In another embodiment, the mount 130 can be at the junction of the first electrochromic device 110 and the second electrochromic device 120. In one embodiment, the mount 130 is along a first side 115 of the first electrochromic device 110 and a first side 125 of the second electrochromic device 120, where the first side 115 of the first electrochromic device 110 is parallel the first side 125 of the second electrochromic device 120. In one embodiment, the mount 130 can be located near about the center of the first side 115 of the first electrochromic device 110, as seen in FIG. 1B. In another embodiment, the mount 130, such as mount 130b, can be located offset from the center of the first side 115 of the second electrochromic device 120. In another embodiment, the mount 130 is adjacent the corner of the first electrochromic device 110, and the second electrochromic device 120. In one embodiment, the mount 130 can connect two electrochromic devices. In another embodiment, the mount 130 can connect three electrochromic devices. In another embodiment, the mount 130 can connect four electrochromic devices. As such, each electrochromic device can have between 1 and 12 mounts. In one embodiment, each electrochromic device has at least one mount 130.

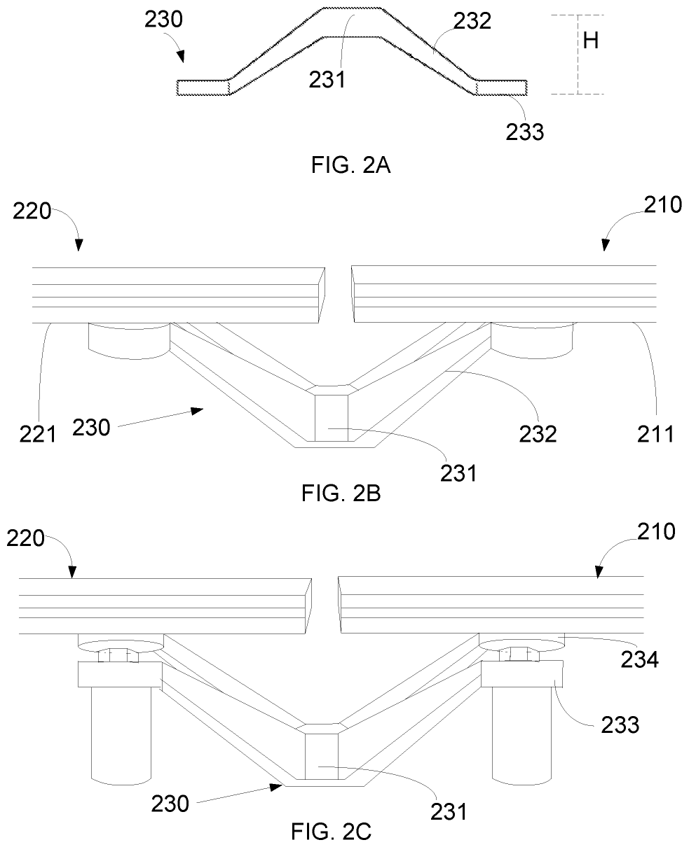

FIGS. 2A, 2B, 2C, and 3 are schematic representation of the mount 130 used in the system 100 of FIG. 1, according to one embodiment. The mount 230 can include a body 231, arms 232, and pads 233. In one embodiment, the mount 230 is one continuous piece machined together. In another embodiment, the mount 230 can be made up of several different pieces later affixed together. The one or more mounts 230 in combination can be used to produce a frameless support for the one or more electrochromic devices. The mount 230 can be a spider hinge mount. In one embodiment, the arms 231 extend radially from the body 231. Each arm can include a varying thickness from the body 231 to the pads 233. In one embodiment, the arms 232 can be on a different plane from the body 231. In one embodiment, the mount 230 has a height H that extends from the top surface of the body to the bottom surface of the pads 233. In one embodiment, the arms extend between 80% and 95% of the height. In one embodiment, the mount 230 can have between 2 and 6 arms. In one embodiment, as seen in FIG. 1B, the mount 230, such as mount 130c, can have 2 arms. In another embodiment, the mount 130 can have 3 arms. In yet another embodiment, as seen in FIG. 3, the mount 230 can have 4 arms.

The pads 233 can be connected at a distal end of each arms 232. In one embodiment, the pads 233 can be circular. In another embodiment, the pads 233 can be rectangular. The pads 233 can be any geometric shape, such as circular, square, rectangular, hexagonal, pentagonal, a parallelogram, etc. Each pad 233 can contact a single surface of the electrochromic device 120. In one embodiment, each pad 233 can contact a single surface of the IGU. As seen in FIG. 2B, pad 233a contacts a first surface 211 of IGU 210 and pad 233b contacts a second surface 221 of IGU 230, where the first surface 211 and the second surface 221 are parallel and on the same plane. Each pad can include a bonding material that allows the mount 230 to support the first IGU 210 and the second IGU 220. The bonding material can be a non-penetrating bonding material. In one embodiment, the bonding material can be selected from the group consisting of a transparent silicone, silicone elastomer, cured rubber, VHB tape, epoxy, and any combination thereof. In another embodiment, the pads 233 can be joined to a second pad 234 using a nut and bolt, as seen in FIG. 2C. In one embodiment, the second pad 234 can be similar material to the pad 233. In another embodiment, the pad 234 can be a different material to the pad 233. The second pad 234 can contain the bonding material to connect the mount 230 to the surface 211.

The pads 233 can contact the single surface without penetrating the IGUs maintaining the hermetic seal and integrity of the electroactive device. Since electrochemical devices contain electrochemical materials that are sensitive not only to environmental factors but also conductive elements, the active layers of electrochemical devices need to be sealed from the environment. By using a framing system that does not puncture or penetrate the active layers or sealed environment surrounding the active layers of the device, the active layers are protected from humidity and other contaminants. In one embodiment, the electrochromic active layers are sealed in a laminate. In another embodiment, the electrochromic active layers are sealed within an IGU, as described in FIG. 5. As such, any framing system that penetrates through either the active layers or the double pane glass compromises the integrity of the device by introducing contaminates that can short the system or environmental factors, such as humidity, that can degrade the active layers. Advantageously, the support system of the present disclosure is non-penetrating but still supportive and able to withstand from 0.1 MPa to 30 MPa loads of force.

In accordance with the present disclosure, FIG. 4 illustrates a cross-section view of a partially fabricated electroactive device 400 having an improved film structure. For purposes of illustrative clarity, the electroactive device 400 is a variable transmission device. In one embodiment, the electroactive device 400 can be an electrochromic device. In another embodiment, the electroactive device 400 can be a thin-film battery. In yet another embodiment, the electroactive device 400 can be a liquid crystal device. In another embodiment, the electroactive device 400 can be an organic light emitting diode device or light emitting diode device. In another embodiment, the electroactive device 400 can be a dichroic device. However, it will be recognized that the present disclosure is similarly applicable to other types of scribed electroactive devices, electrochemical devices, as well as other electrochromic devices with different stacks or film structures (e.g., additional layers). The electroactive devices can be laminates or can be part of an insulated glazing unit, as described below.

With regard to the electrochemical device 400 of FIG. 4, the device 400 may include a substrate 410 and a stack overlying the substrate 410. The stack may include a first transparent conductor layer 422, a cathodic electrochemical layer 424, an anodic electrochemical layer 428, and a second transparent conductor layer 430. In one embodiment, the stack may also include an ion conducting layer 426 between the cathodic electrochemical layer 424 and the anodic electrochemical layer 428.

In an embodiment, the substrate 410 can include a glass substrate, a sapphire substrate, an aluminum oxynitride substrate, or a spinel substrate. In another embodiment, the substrate 410 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 410 may or may not be flexible. In a particular embodiment, the substrate 410 can be float glass or a borosilicate glass and have a thickness in a range of 0.5 mm to 12 mm thick. The substrate 410 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 410 can include ultra-thin glass that is a mineral glass having a thickness in a range of 50 microns to 300 microns. In a particular embodiment, the substrate 410 may be used for many different electrochemical devices being formed and may referred to as a motherboard.

Transparent conductive layers 422 and 430 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 422 and 430 can include gold, silver, copper, nickel, aluminum, or any combination thereof. The transparent conductive layers 422 and 430 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 422 and 430 can have a thickness between 10 nm and 600 nm. In one embodiment, the transparent conductive layers 422 and 430 can have a thickness between 200 nm and 500 nm. In one embodiment, the transparent conductive layers 422 and 430 can have a thickness between 320 nm and 460 nm. In one embodiment the first transparent conductive layer 422 can have a thickness between 10 nm and 600 nm. In one embodiment, the second transparent conductive layer 430 can have a thickness between 80 nm and 600 nm.

The layers 424 and 428 can be electrode layers, wherein one of the layers may be a cathodic electrochemical layer, and the other of the layers may be an anodic electrochromic layer (also referred to as a counter electrode layer). In one embodiment, the cathodic electrochemical layer 424 is an electrochromic layer. The cathodic electrochemical layer 424 can include an inorganic metal oxide material, such as WO₃, V₂O₅, MoO₃, Nb₂O₅, TiO₂, CuO, Ni₂O₃, NiO, Ir₂O₃, Cr₂O³, CO₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 424 can have a thickness between 100 nm to 400 nm. In one embodiment, the cathodic electrochemical layer 424 can have a thickness between 350 nm to 390 nm. The cathodic electrochemical layer 424 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 428 can include any of the materials listed with respect to the cathodic electrochromic layer 424 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 428 can have a thickness between 150 nm to 300 nm. In one embodiment, the anodic electrochromic layer 428 can have a thickness between 250 nm to 290 nm. In some embodiments, lithium may be inserted into at least one of the first electrode 430 or second electrode 440.

In another embodiment, the device 400 may include a plurality of layers between the substrate 410 and the first transparent conductive layer 422. In one embodiment, an antireflection layer can be between the substrate 410 and the first transparent conductive layer 422. The antireflection layer can include SiO₂, NbO₂, Nb₂O₅ and can be a thickness between 20 nm to 100 nm. The device 400 may include at least two bus bars with one bus bar 444 electrically connected to the first transparent conductive layer 422 and the second bus bar 448 electrically connected to the second transparent conductive layer 430.

Any of the electrochromic devices can be subsequently processed as a part of an insulated glass unit or laminate device. FIG. 5 is a schematic illustration of an insulated glazing unit 500 according the embodiment of the current disclosure. The insulated glass unit 500 can include a first panel 505, an electrochemical device 520 coupled to the first panel 505, a second panel 510, and a spacer 515 between the first panel 505 and second panel 510. The first panel 505 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 505 may or may not be flexible. In a particular embodiment, the first panel 505 can be float glass or a borosilicate glass and have a thickness in a range of 2 mm to 20 mm thick. The first panel 505 can be a heat-treated, heat-strengthened, or tempered panel. In one embodiment, the electrochemical device 520 is coupled to first panel 505. In another embodiment, the electrochemical device 520 is on a substrate 525 and the substrate 525 is coupled to the first panel 505. In one embodiment, a lamination interlayer 530 may be disposed between the first panel 505 and the electrochemical device 520. In one embodiment, the lamination interlayer 530 may be disposed between the first panel 505 and the substrate 525 containing the electrochemical device 520. The electrochemical device 520 may be on a first side 521 of the substrate 525 and the lamination interlayer 530 may be coupled to a second side 522 of the substrate. The first side 521 may be parallel to and opposite from the second side 522.

The second panel 510 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 510 can be float glass or a borosilicate glass and have a thickness in a range of 5 mm to 30 mm thick. The second panel 510 can be a heat-treated, heat-strengthened, or tempered panel. In one embodiment, the spacer 515 can be between the first panel 505 and the second panel 5510. In another embodiment, the spacer 515 is between the substrate 525 and the second panel 510. In yet another embodiment, the spacer 515 is between the electrochemical device 520 and the second panel 510.

In another embodiment, the insulated glass unit 500 can further include additional layers. The insulated glass unit 500 can include the first panel, the electrochemical device 520 coupled to the first panel 505, the second panel 510, the spacer 515 between the first panel 505 and second panel 510, a third panel, and a second spacer between the first panel 505 and the second panel 510. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

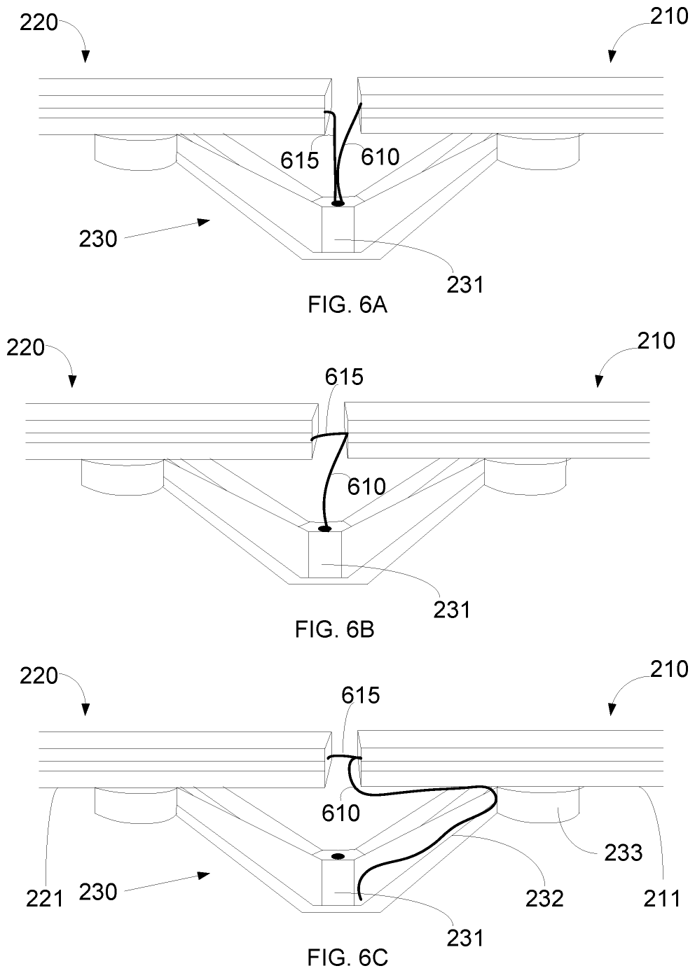

FIGS. 6A-6C each show a schematic representation of the wiring of the support system, according to different embodiment. As part of the support system, additional mounting hardware (not shown) can be used in combination with the spider mounts described above. In one embodiment, the gap in between the panes can be filled using a flexible sealant. Additionally, as shown in FIG. 6A the wiring used to power the electrochromic devices can also be ran through the body 231 of the mount 230. In one embodiment, a first wire 610, used to power the device 210, and a second wire 615, used to power the device 220, can run in a gap between the device 210 and device 220 and through the mount 230. In another embodiment, the first wire 610 can run along the edge of the device 210 and the second wire 615 can run along the edge of the device 220 before going through the mount 230. In another embodiment, as seen in FIG. 6B, the first wire 610 can run through the mount 230 while the second wire 615 runs from the first device 210 to the second device 220. In such an embodiment, several devices can be connected to one another and a single wire can run through the mount 230. In yet another embodiment, as seen in FIG. 6C, the first wire 610 can run along the surface 211 of the first device 210 and down the arm 232 of the mount 230 while the second wire 615 runs from the first device 210 to the second device 220. In yet another embodiment, both the first wire 610 and the second wire 615 can run along the surface of the device 210 and along the same arm of the mount 230. In another embodiment, the first wire 610 can run along the surface 211 of the device 210 and the second wire can run along the surface 221 of the second device 220 before running along different arms of the mount towards the body 231. Though only two wires are shown, it should be understood that the placement of wires can expand to as many devices as are in the system. Once through the body 231, the wires can continue through conduits (not shown) attached to the body 231 of the mount 230. The wires could be attached using connectors along the arms or body. In one embodiment, the wires could run along the exterior surface of the mount.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A frameless support system including: a non-penetrating mount; a first electroactive device; a second electroactive device adjacent the first electroactive device, where the non-penetrating mount connects the first electroactive device to the second electroactive device, and where the non-penetrating mount is on only a single surface of the first and second electroactive devices.

Embodiment 2. A frameless support system including: a non-penetrating mount; a first electrochromic device; a second electrochromic device adjacent the first electrochromic device, where both the first and second electrochromic devices can further include: a substrate; a first transparent conductive layer; a second transparent conductive layer between the substrate and the first transparent conductive layer; an electrochromic layer between the first transparent conductive layer and the second transparent conductive layer; and an anodic electrochemical layer between the first transparent conductive layer and the second transparent conductive layer; and where the non-penetrating mount is on only a single surface of the first and second electrochromic devices.

Embodiment 3. A frameless support system including: a non-penetrating mount; a first electrochromic device; a second electrochromic device adjacent the first electrochromic device, where both the first and second electrochromic devices can further include: a substrate; a first transparent conductive layer; a second transparent conductive layer between the substrate and the first transparent conductive layer; an electrochromic layer between the first transparent conductive layer and the second transparent conductive layer; and an anodic electrochemical layer between the first transparent conductive layer and the second transparent conductive layer; and where the non-penetrating mount connects the first electrochromic device to the second electrochromic device, and where the non-penetrating mount does not penetrate the first electrochromic device.

Embodiment 4. The frameless support system of embodiment 1, where at least one of electroactive devices is a liquid crystal device.

Embodiment 5. The frameless support system of embodiment 1, where at least one of the electroactive devices is an electrochromic device.

Embodiment 6. The frameless support system of embodiment 5, where both the first and second electroactive devices can further include: a substrate; a first transparent conductive layer; a second transparent conductive layer between the substrate and the first transparent conductive layer; an electrochromic layer between the first transparent conductive layer and the second transparent conductive layer; and an anodic electrochemical layer between the first transparent conductive layer and the second transparent conductive layer.

Embodiment 7. The frameless support system of embodiment 1, where the non-penetrating mount is able to withstand between 0.1 MPa to 30 MPa of force.

Embodiment 8. The frameless support system of embodiment 1, where the non-penetrating mount can include a body, at least two arms, and at least two pads.

Embodiment 9. The frameless support system of embodiment 3, where the non-penetrating mount can include four arms.

Embodiment 10. The frameless support system of embodiment 3, where the non-penetrating mount can include between 2 and 6 arms.

Embodiment 11. The frameless support system of embodiment 3, where the non-penetrating mount can include between 2 and 6 pads.

Embodiment 12. The frameless support system of embodiment 1, where the first electrochromic device can include a first surface on a first plane.

Embodiment 13. The frameless support system of embodiment 3, where the non-penetrating mount is along a first edge of the first surface of the first electrochromic device.

Embodiment 14. The frameless support system of embodiment 6, where the second electrochromic device can include a first surface on a second plane, where the first plane and the second plane are the same.

Embodiment 15. The frameless support system of embodiment 14, where the non-penetrating mount is along a first edge of the first surface of the second electrochromic device.

Embodiment 16. The frameless support system of embodiment 15, where the non-penetrating mount is about a center of the first edge of the second electrochromic device.

Embodiment 17. The frameless support system of embodiment 15, where the non-penetrating mount is about a corner of the first edge of the second electrochromic device.

Embodiment 18. The frameless support system of embodiment 15, where the non-penetrating mount is along the first edge of the second electrochromic device away from the center of the first edge of the second electrochromic device.

Embodiment 19. The frameless support system of embodiment 6, where the substrate can include glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 20. The frameless support system of embodiment 6, where each of the one or more electrochromic devices further can include an ion conducting layer between the cathodic electrochemical layer and the anodic electrochemical layer.

Embodiment 21. The frameless support system of embodiment 20, where the ion-conducting layer can include lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 22. The frameless support system of embodiment 6, where the electrochromic layer can include WO₃, V₂O₅, MoO₃, Nb₂O5, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 23. The frameless support system of embodiment 6, where the first transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 24. The frameless support system of embodiment 6, where the second transparent conductive layer can include indium oxide, indium tin oxide, doped indium oxide, tin oxide, doped tin oxide, zinc oxide, doped zinc oxide, ruthenium oxide, doped ruthenium oxide and any combination thereof.

Embodiment 25. The frameless support system of embodiment 6, where the anodic electrochemical layer can include a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO2, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A frameless support system comprising:
a non-penetrating mount;
a first electroactive device;
a second electroactive device adjacent the first electroactive device,
wherein the non-penetrating mount connects the first electroactive device to the second electroactive device, and wherein the non-penetrating mount is on only a single surface of the first and second electroactive devices.

2. The frameless support system of claim 1, wherein at least one of electroactive devices is a liquid crystal device.

3. The frameless support system of claim 1, wherein at least one of the electroactive devices is an electrochromic device.

4. The frameless support system of claim 3, wherein both the first and second electroactive devices further comprise:
a substrate;
a first transparent conductive layer;
a second transparent conductive layer between the substrate and the first transparent conductive layer;
an electrochromic layer between the first transparent conductive layer and the second transparent conductive layer; and
an anodic electrochemical layer between the first transparent conductive layer and the second transparent conductive layer.

5. The frameless support system of claim 1, wherein the non-penetrating mount is able to withstand between 0.1 MPa to 30 MPa of force.

6. The frameless support system of claim 1, wherein the non-penetrating mount comprises a body, at least two arms, and at least two pads.

7. The frameless support system of claim 1, wherein the first electrochromic device comprises a first surface on a first plane.

8. The frameless support system of claim 7, wherein the second electrochromic device comprises a first surface on a second plane, wherein the first plane and the second plane are the same.

9. The frameless support system of claim 8, wherein the non-penetrating mount is along a first edge of the first surface of the second electrochromic device.

10. The frameless support system of claim 9, wherein the non-penetrating mount is about a center of the first edge of the second electrochromic device.

11. The frameless support system of claim 9, wherein the non-penetrating mount is about a corner of the first edge of the second electrochromic device.

12. The frameless support system of claim 9, wherein the non-penetrating mount is along the first edge of the second electrochromic device away from the center of the first edge of the second electrochromic device.

13. A frameless support system comprising:
a non-penetrating mount;
a first electrochromic device;
a second electrochromic device adjacent the first electrochromic device, wherein both the first and second electrochromic devices further comprise:
a substrate;
a first transparent conductive layer;
a second transparent conductive layer between the substrate and the first transparent conductive layer;
an electrochromic layer between the first transparent conductive layer and the second transparent conductive layer; and
an anodic electrochemical layer between the first transparent conductive layer and the second transparent conductive layer; and
wherein the non-penetrating mount is on only a single surface of the first and second electrochromic devices.

14. The frameless support system of claim 13, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

15. The frameless support system of claim 14, wherein each of the one or more electrochromic devices further comprises an ion conducting layer between the cathodic electrochemical layer and the anodic electrochemical layer.

16. A frameless support system comprising:
a non-penetrating mount;
a first electrochromic device;
a second electrochromic device adjacent the first electrochromic device, wherein both the first and second electrochromic devices further comprise:
a substrate;
a first transparent conductive layer;
a second transparent conductive layer between the substrate and the first transparent conductive layer;
an electrochromic layer between the first transparent conductive layer and the second transparent conductive layer; and
an anodic electrochemical layer between the first transparent conductive layer and the second transparent conductive layer; and
wherein the non-penetrating mount connects the first electrochromic device to the second electrochromic device, and wherein the non-penetrating mount does not penetrate the first electrochromic device.

17. The frameless support system of claim 16, wherein the non-penetrating mount comprises four arms.

18. The frameless support system of claim 16, wherein the non-penetrating mount comprises between 2 and 6 arms.

19. The frameless support system of claim 16, wherein the non-penetrating mount comprises between 2 and 6 pads.

20. The frameless support system of claim 16, wherein the non-penetrating mount is along a first edge of the first surface of the first electrochromic device.
